(19) United States
(12) Patent Application Publication
(10) Pub. No.: US 2026/0007506 A1
(43) Pub. Date: Jan. 8, 2026

(54) AUTOMATED ORAL HYGIENE DEVICE

(71) Applicant: Carlos Rodas, Downey, CA (US)

(72) Inventor: Carlos Rodas, Downey, CA (US)

(21) Appl. No.: 18/762,364

(22) Filed: Jul. 2, 2024

(51) Int. Cl. A61C 17/22; A61C 17/02; A61C 17/024

(52) U.S. Cl. CPC A61C 17/228; A61C 17/0211; A61C 17/024

(57) ABSTRACT

An automated oral hygiene device includes a mouthpiece which is U-shaped to surround either an upper row of a user's teeth or a lower row of the user's teeth when the mouthpiece is positioned in the user's mouth. A water recirculation unit is integrated into the mouthpiece to recirculate water through the mouthpiece and subsequently rinse the user's mouth when the mouthpiece is positioned in the user's mouth. A plurality of brushing units is each movably integrated into the mouthpiece to abut respective ones of the upper row of the user's teeth or respective ones of the lower row of the user's teeth depending upon the positioning of the mouthpiece in the user's mouth. Each of the plurality of brushing units moves back and forth to brush the respective ones of the upper row of the user's teeth or the respective ones of the lower row of the user's teeth.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to oral hygiene devices and more particularly pertains to a new oral hygiene device for automatically brushing and rinsing a user's teeth. The device includes a U-shaped mouthpiece that is positionable in a user's mouth to surround either the user's upper row of teeth or the user's lower row of teeth. The device includes a water recirculation unit which recirculates water into and out of the mouthpiece for rinsing the user's mouth when the mouthpiece is positioned in the user's mouth. The device includes a plurality of brushing units which is each movably integrated into the mouthpiece. The plurality of brushing units brushes the user's teeth when the mouthpiece is positioned in the user's mouth for automatically brushing and rinsing the user's teeth.

### (2) Description of Related Art Including Information Disclosed Under 37 CFR 1.97 and 1.98

The prior art relates to oral hygiene devices including a variety of automated dental hygiene devices that each at least includes a U-shaped mouthpiece and plurality of bristle units movably integrated into the U-shaped mouthpiece for automatically brushing a user's teeth and a powered dental hygiene device that includes a U-shaped mouthpiece and a plurality of interchangeable accessories for brushing, polishing and irrigating a user's teeth. In no instance does the prior art disclose an automated dental hygiene device that includes a U-shaped mouthpiece and a plurality of bristle units movably integrated into the mouthpiece for brushing a user's teeth and a water recirculation unit for recirculating water into and out of the U-shaped mouthpiece for rinsing the user's teeth.

### BRIEF SUMMARY OF THE INVENTION

An embodiment of the disclosure meets the needs presented above by generally comprising a mouthpiece which is U-shaped to surround either an upper row of a user's teeth or a lower row of the user's teeth when the mouthpiece is positioned in the user's mouth. A water recirculation unit is integrated into the mouthpiece to recirculate water through the mouthpiece and subsequently rinse the user's mouth when the mouthpiece is positioned in the user's mouth. A plurality of brushing units is each movably integrated into the mouthpiece to abut respective ones of the upper row of the user's teeth or respective ones of the lower row of the user's teeth depending upon the positioning of the mouthpiece in the user's mouth. Each of the plurality of brushing units moves back and forth to brush the respective ones of the upper row of the user's teeth or the respective ones of the lower row of the user's teeth.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an automated oral hygiene device according to an embodiment of the disclosure.

FIG. 2 is a right side phantom view of an embodiment of the disclosure.

FIG. 3 is a top view of an embodiment of the disclosure.

FIG. 4 is a bottom perspective phantom view of an embodiment of the disclosure.

FIG. 5 is a cross sectional view taken along line 5-5 of FIG. 3 of an embodiment of the disclosure.

FIG. 6 is a cross sectional view taken along line 6-6 of FIG. 3 of an embodiment of the disclosure.

FIG. 7 is a perspective in-use view of an embodiment of the disclosure.

FIG. 8 is a schematic view of an embodiment of the disclosure.

### DETAILED DESCRIPTION OF THE INVENTION

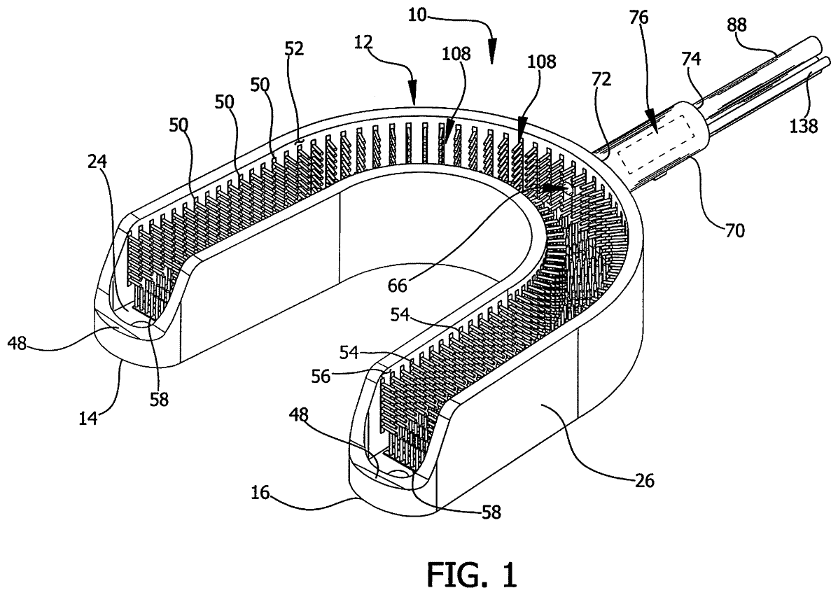

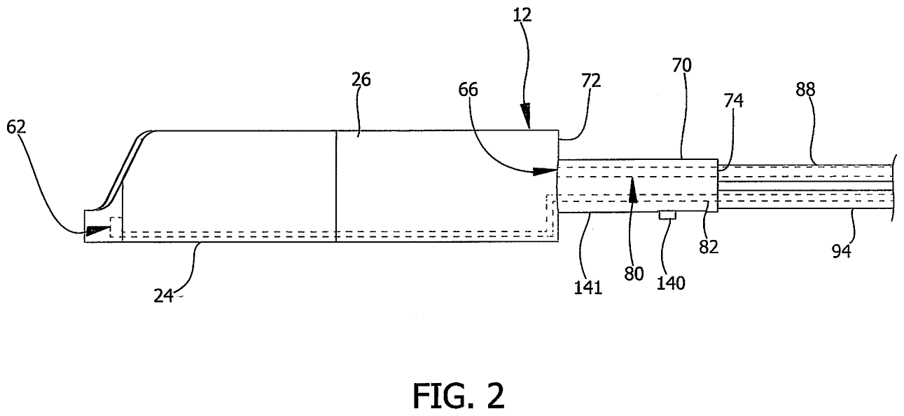

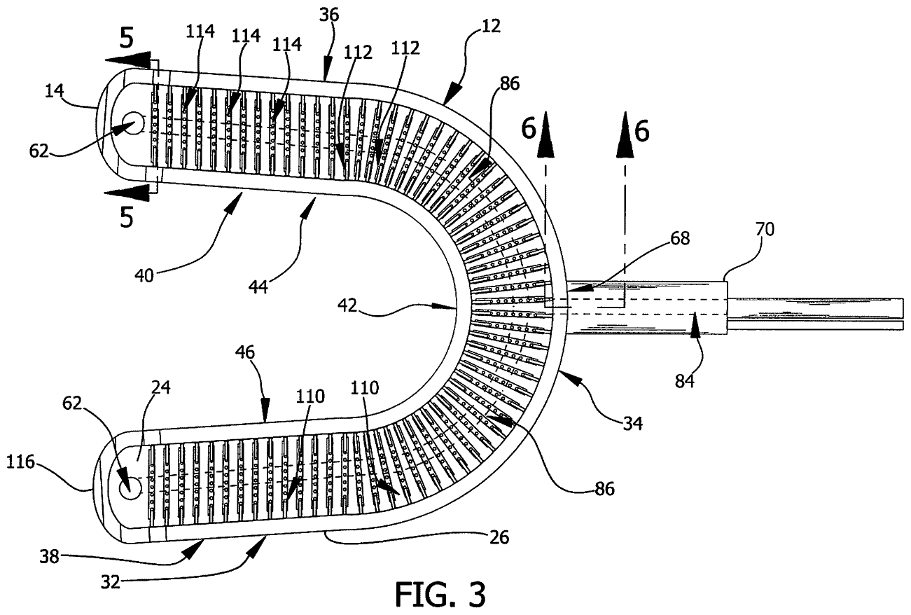

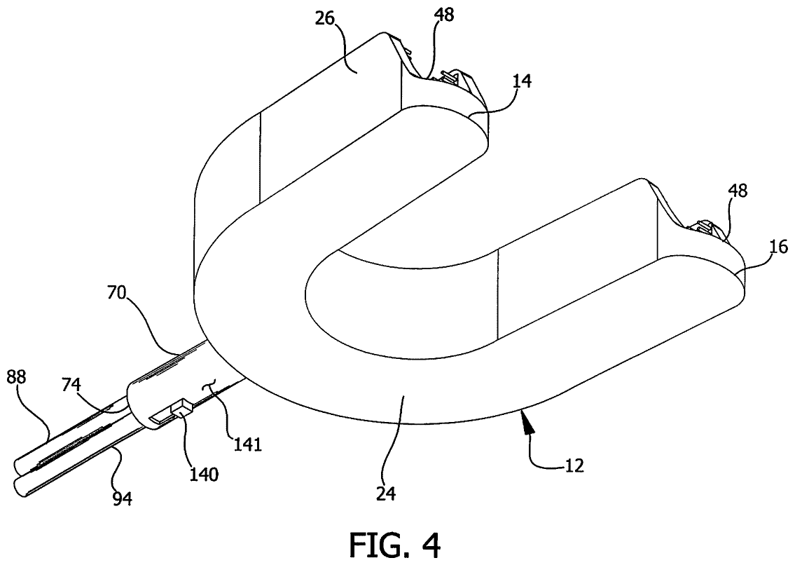

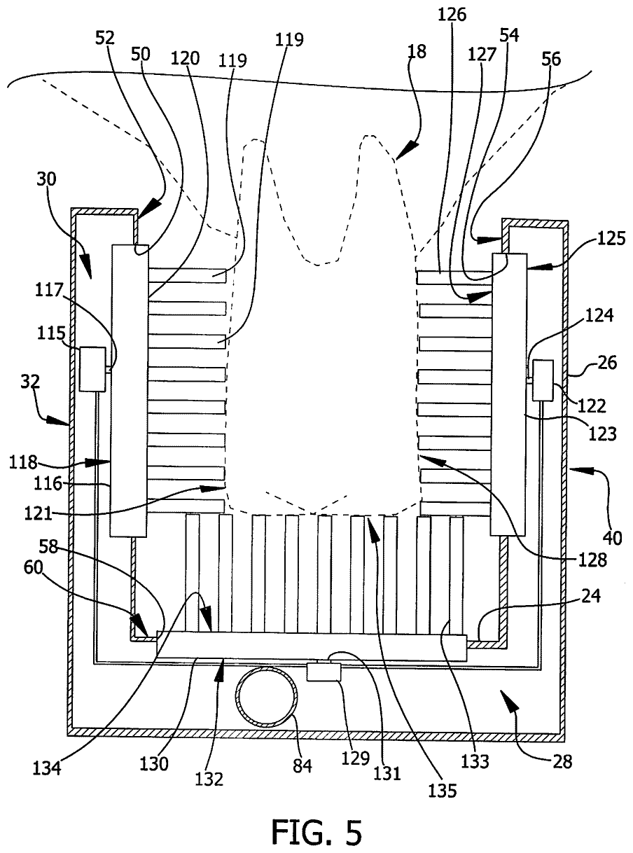

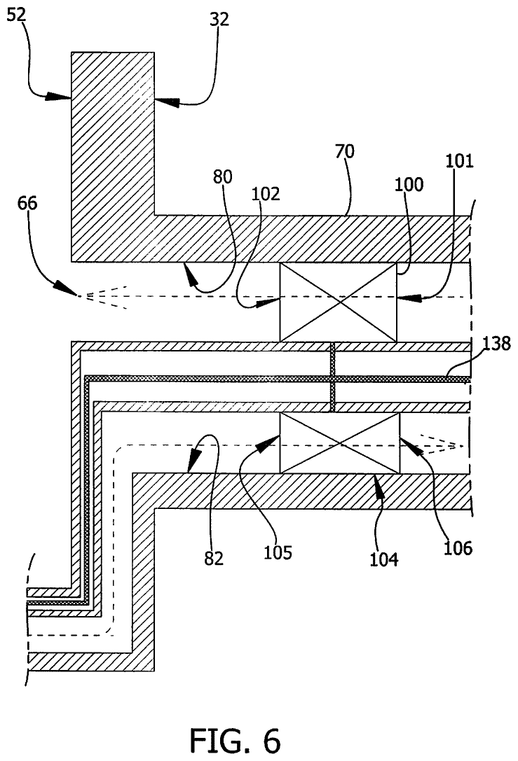

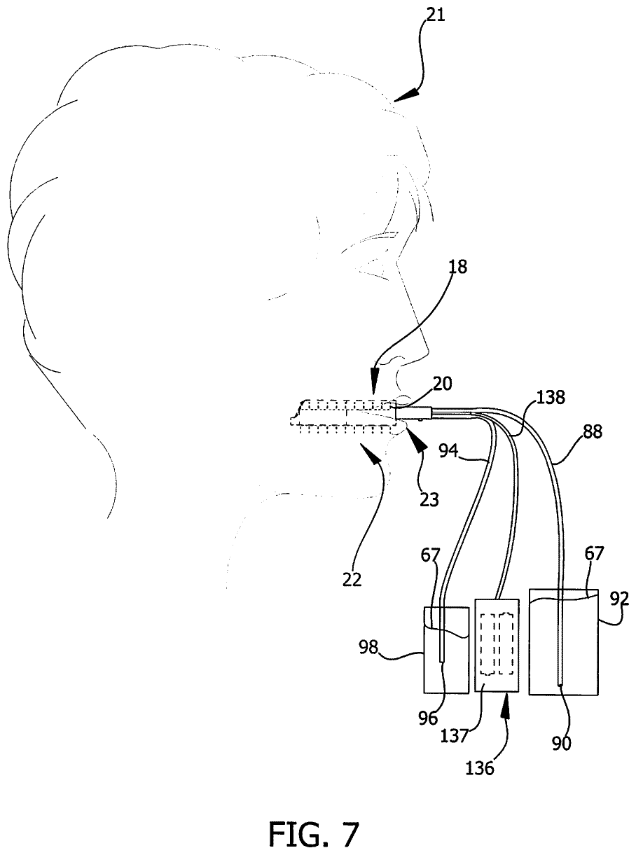

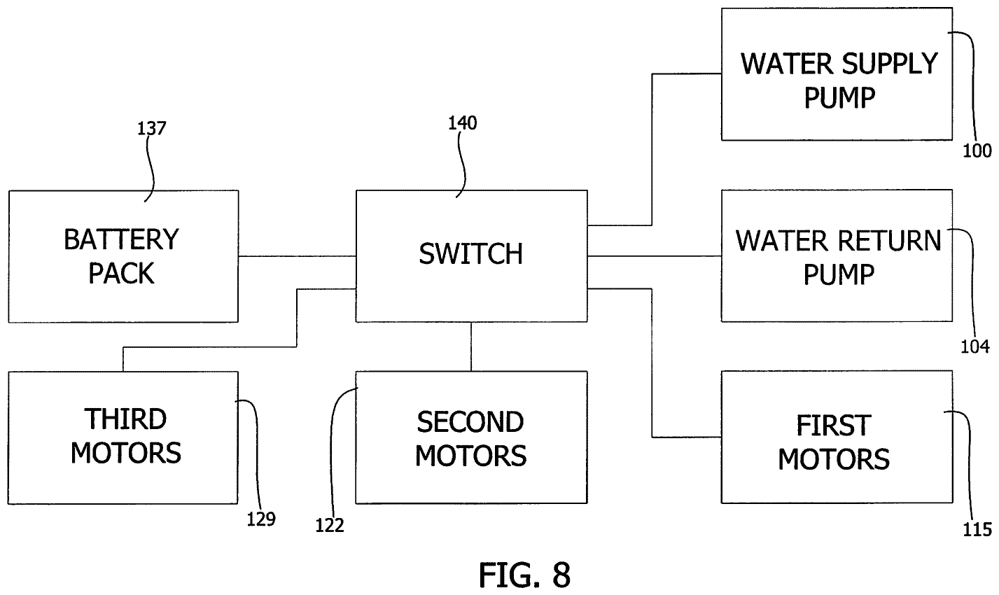

With reference now to the drawings, and in particular to FIGS. 1 through 8 thereof, a new oral hygiene device embodying the principles and concepts of an embodiment of the disclosure and generally designated by the reference numeral 10 will be described.

As best illustrated in FIGS. 1 through 8, the automated oral hygiene device 10 generally comprises a mouthpiece 12 which is curved between a first end 14 and a second end 16 of the mouthpiece 12 such that the mouthpiece 12 has a U-shape. In this way the mouthpiece 12 can surround either an upper row 18 of teeth 20 of a user 21 or a lower row 22 of the user's teeth 20 when the mouthpiece 12 is positioned in the user's mouth 23. The mouthpiece 12 is comprised of a resiliently compressible and fluid impermeable material, including but not being limited to silicone or rubber, such that the mouthpiece 12 is inhibited from damaging the user's teeth 20. The mouthpiece 12 has a basal wall 24 and a perimeter wall 26 extending upwardly from the basal wall 24 and each of the basal wall 24 and the perimeter wall 26 is substantially hollow to define an interior space 28 in the basal wall 24 which is in fluid communication with an interior space 30 of the perimeter wall 26.

The perimeter wall 26 has an outwardly facing wall 32 which has a central portion 34 that curves outwardly between a first lateral side 36 and a second lateral side 38 such that the outwardly facing wall 32 defines a U-shape. The first lateral side 36 terminates at the first end 14 of the mouthpiece 12 and the second lateral side 38 terminates at the second end 16 of the mouthpiece 12. The perimeter wall 26 has an inwardly facing wall 40 which has a middle portion 42 that curves outwardly between a first sidelong side 44 and a second sidelong side. Additionally, the first sidelong side 44 is spaced from and is oriented parallel to the first lateral side 36 of the outwardly facing wall 32; the second sidelong side 46 is spaced from and is oriented parallel to the second lateral side 38 of the outwardly facing wall 32. The middle portion 42 is spaced from and is co-arcuate with the central portion 34 of the outwardly facing wall 32.

The first sidelong side 44 terminates at the first end 14 of the mouthpiece 12. The second sidelong side 46 terminates at the second end 16 of the mouthpiece 12. Additionally, the basal wall 24 has a pair of lips 48 which each extends upwardly from the basal wall 24 and each of the lips 48 extends between the outwardly facing wall 32 and the inwardly facing wall 40. Each of the pair of lips 48 is aligned with a respective one of the first end 14 and the second end 16 of the mouthpiece 12. Furthermore, each of the inwardly facing wall 40 and the outwardly facing wall 32 slopes downwardly at each of the lips 48.

The outwardly facing wall 32 has a plurality of first slots 50 each extending through an inwardly facing surface 52 of the outwardly facing wall 32 and each of the plurality of first slots 50 is vertically oriented on the outwardly facing wall 32. Additionally, the plurality of first slots 50 is evenly spaced apart from each other and is distributed between the first end 14 of the mouthpiece 12 and the second end 16 of the mouthpiece 12. The inwardly facing wall 40 has a plurality of second slots 54 each extending through an inwardly facing surface 56 of the inwardly facing wall 40 and each of the plurality of second slots 54 is vertically oriented on the inwardly facing wall 40. The plurality of second slots 54 is evenly spaced apart from each other and is distributed between the first end 14 of the mouthpiece 12 and the second end 16 of the mouthpiece 12. The basal wall 24 has a plurality of third slots 58 each extending through an upper surface 60 of the basal wall 24 and the plurality of third slots 58 is oriented to extend substantially between the outwardly facing wall 32 and the inwardly facing wall 40. The plurality of third slots 58 is evenly spaced apart from each other and is distributed between the first end 14 of the mouthpiece 12 and the second end 16 of the mouthpiece 12.

The basal wall 24 has a pair of water intake holes 62 each extending through the upper surface 60 of the basal wall 24 and into the interior space 28 in the basal wall 24 to pass water 67 through the basal wall 24. Each of the pair of water intake holes 62 is positioned between a respective one of the first end 14 and the second end 16 of the mouthpiece 12 and a respective one of a pair of endmost ones 64 of the plurality of third slots 58 in the basal wall 24. Additionally, the outwardly facing wall 32 has a water outlet hole 66 extending through the inwardly facing surface 52 of the outwardly facing wall 32 and into the interior space 30 in the perimeter wall 26 to pass water 67 through the outwardly facing wall 32. The water outlet hole 66 is aligned with an apex 68 of the central portion 34 of the outwardly facing wall 32.

A stem 70 is coupled to and extends away from an outwardly facing surface 72 of the central portion 34 of the outwardly facing wall 32 of the perimeter wall 26 of the mouthpiece 12. The stem 70 is aligned with the apex 68 of the outwardly facing wall 32. Additionally, the stem 70 has a distal end 74 with respect to the outwardly facing surface 72 of the central portion 34 and the distal end 74 is open. The stem 70 is comprised of a resiliently compressible material, including but not being limited to rubber or silicone.

A water recirculation unit 76 is integrated into the mouthpiece 12 to recirculate water 67 into and out of the mouthpiece 12 when the mouthpiece 12 is positioned in the user's mouth 23 thereby rinsing the user's mouth 23. The water recirculation unit 76 comprises a water supply conduit 80 which is integrated into the stem 70 and the water supply conduit 80 is in fluid communication with the water outlet hole 66. The water recirculation unit 76 includes a water return conduit 82 which is integrated into the mouthpiece 12. The water return conduit 82 has a stem portion 84 which is integrated into the stem 70 and a pair of branch portions 86 which is each positioned in the interior space 28 of the basal wall 24 of the mouthpiece 12. Additionally, each of the pair of branch portions 86 is in fluid communication with a respective one of the pair of water intake holes 62.

The water recirculation unit 76 includes a water supply hose 88 which is coupled to and extends away from the distal end 74 of the stem 70. A distal end 90 of the water supply hose 88 is insertable into a supply water reservoir 92 such that the distal end 90 of the water supply hose 88 can be submerged in water 67 contained in the supply water reservoir 92. Furthermore, the water supply hose 88 is fluidly coupled to the water outlet hole 66 in the outwardly facing wall 32 of the perimeter wall 26 of the mouthpiece 12. The water recirculation unit 76 includes a water return hose 94 which is coupled to and extends away from the distal end 74 of the stem 70. A distal end 96 of the water return hose 94 is insertable into a return water reservoir 98 and the water return hose 94 is fluidly coupled to the stem portion 84 of the water return conduit 82 in the stem 70.

The water recirculation unit 76 includes a water supply pump 100 which is positioned within the water supply hose 88 and the water supply pump 100 has an input 101 and an output 102. The water supply pump 100 urges water 67 from supply water reservoir 92 into the input 101 and outwardly through output 102 to urge the water 67 in the supply water reservoir 92 outwardly through the water outlet hole 66 in the outwardly facing wall 32 of the perimeter wall 26 of the mouthpiece 12. In this way the water supply pump 100 directs the water 67 onto the user's teeth 20 when the mouthpiece 12 is being worn by the user 21. The water supply pump 100 may comprise an electric fluid pump or the like which has an output capacity of approximately 7.4 ml per second.

The water recirculation unit 76 includes a water return pump 104 which is positioned within the stem portion 84 of the water return conduit 82 and the water return pump 104 has an input 105 and an output 106. The water return pump 104 urges water 67 from the stem portion 84 of the water return conduit 82 into the input 105 of the water return pump 104 and outwardly through the output 106 of the water return pump 104. In this way the water return pump 104 urges the water 67 in the mouthpiece 12 into the return water reservoir 98 through the water return hose 94. Furthermore, the water return pump 104 may comprise an electric fluid pump which has an output capacity of approximately 7.4 ml per second.

A plurality of brushing units 108 is each movably integrated into the mouthpiece 12 such that each of the plurality of brushing units 108 abuts respective ones of the upper row 18 of the user's teeth 20 or respective ones of the lower row 22 of the user's teeth 20 depending upon the positioning of the mouthpiece 12 in the user's mouth 23. Each of the plurality of brushing units 108 moves back and forth when the plurality of brushing units 108 is turned on. In this way each of the plurality of brushing units 108 can brush the respective ones of the upper row 18 of the user's teeth 20 or the respective ones of the lower row 22 of the user's teeth 20 thereby enhancing the dental health of the user 21. The plurality of brushing units 108 includes a set of outwardly facing wall brushing units 110 and a set of inwardly facing wall brushing units 112 and a set of basal wall brushing units 114.

Each of the set of outwardly facing wall brushing units 110 includes a first motor 115 which is positioned within the interior space 30 of the outwardly facing wall 32 of the perimeter wall 26 of the mouthpiece 12. The first motor 115 may comprise an electric motor or the like which produces a back and forth motion. Each of the outwardly facing wall brushing units 110 includes a first panel 116 which is slidably positioned in a respective one of the first slots 50 in the outwardly facing wall 32 of the perimeter wall 26 of the mouthpiece 12. Additionally, each of the outwardly facing wall brushing units 110 includes a first output shaft 117 which is coupled between the first motor 115 and a rear surface 118 of the first panel 116. The first panel 116 is urged upwardly and downwardly in the respective first slot 50 when the first motor 115 is turned on.

Each of the outwardly facing wall brushing units 110 includes a plurality of first bristles 119 and each of the plurality of first bristles 119 is coupled to and extends away from a front surface 120 of the first panel 116. In this way each of the plurality of first bristles 119 can frictionally engage a first lateral side 121 of a respective one of the user's teeth 18 when the user 21 wears the mouthpiece 12 thereby facilitating the plurality of first bristles 119 to scrub the respective user's tooth 18 when the first motor 115 is turned on. The plurality of first bristles 119 is evenly spaced apart from each other and is distributed along a full height of the first panel 116.

Each of the set of inwardly facing wall brushing units 112 includes a second motor 122 which is positioned within the interior space 30 of the inwardly facing wall 40 of the perimeter wall 26 of the mouthpiece 12. The second motor 122 may comprise an electric motor or the like which produces a back and forth motion. Each of the inwardly facing wall brushing units 112 includes a second panel 123 which is slidably positioned in a respective one of the second slots 54 in the inwardly facing wall 40 of the perimeter wall 26 of the mouthpiece 12. Additionally, each of the inwardly facing wall brushing units 112 includes a second output shaft 124 which is coupled between the second motor 122 and a rear surface 125 of the second panel 123. Furthermore, the second panel 123 is urged upwardly and downwardly in the respective second slot 54 when the second motor 122 is turned on. Each of the inwardly facing wall brushing units 112 includes a plurality of second bristles 126 which is each coupled to and extends away from a front surface 127 of the second panel 123. In this way each of the plurality of second bristles 126 can frictionally engage a second lateral side 128 of a respective one of the user's teeth 18 when the user 21 wears the mouthpiece 12 thereby facilitating the plurality of second bristles 126 to scrub the respective user's tooth 18 when the second motor 122 is turned on. Furthermore, the plurality of second bristles 126 is evenly spaced apart from each other and is distributed along a full height of the second panel 123.

Each of the set of basal wall brushing units 114 includes a third motor 129 which is positioned within the interior space 28 of the basal wall 24 of the mouthpiece 12. The third motor 129 may comprise an electric motor or the like which produces a back and forth motion. Each of the set of basal wall brushing units 114 includes a third panel 130 which is slidably positioned in a respective one of the third slots 58 in the basal wall 24 of the mouthpiece 12. Additionally, each of the basal wall brushing units 114 includes a third output shaft 131 which is coupled between the third motor 129 and a rear surface 132 of the third panel 130. Furthermore, the third panel 130 is urged back and forth laterally in the respective third slot 58 when the third motor 129 is turned on. Each of the basal wall brushing units 114 includes a plurality of third bristles 133 which is each coupled to and extends away from a front surface 134 of the third panel 130. Furthermore, each of the plurality of third bristles 133 frictionally engages a crown surface 135 of a respective one of the user's teeth 18 when the user 21 wears the mouthpiece 12 thereby facilitating the plurality of third bristles 133 to scrub the respective user's tooth when the third motor 129 is turned on. Additionally, the plurality of third bristles 133 is evenly spaced apart from each other and is distributed along a full height of the third panel 130.

A power supply 136 is provided and the power supply 136 is integrated into the mouthpiece 12. The power supply 136 is electrically coupled to each of the water supply pump 100, the water return pump 104, the first motor 115 of each of the outwardly facing wall brushing units 110, the second motor 122 of each of the inwardly facing wall brushing units 112 and the third motor 129 of each of the basal wall brushing units 114. The power supply 136 comprises a battery pack 137 which is remotely located with respect to the mouthpiece 12 and a power cord 138 which extends away from the distal end 74 of the stem 70 on the mouthpiece 12. The power cord 138 is electrically coupled to the battery pack 137 and the power cord 138 is electrically coupled to the first motor 115 of each of the set of outwardly facing wall brushing units 110, the second motor 122 of each of the inwardly facing wall brushing units 112, the third motor 129 of each of the basal wall brushing units 114, the water supply pump 100 and the water return pump 104.

The power supply 136 includes a power switch 140 which is slidably integrated into a lower surface 141 of the stem 70 such that the power switch 140 can be manipulated by the user 21. The power cord 138 is routed through the power switch 140. In this way the power switch 140 interrupts power to the first motor 115 of each of the set of outwardly facing wall brushing units 110, the second motor 122 of each of the inwardly facing wall brushing units 112, the third motor 129 of each of the basal wall brushing units 114, the water supply pump 100 and the water return pump 104 when the power switch 140 is slid into an off position. Conversely, the power switch 140 facilitates power to be delivered to the first motor 115 of each of the set of outwardly facing wall brushing units 110, the second motor 122 of each of the inwardly facing wall brushing units 112, the third motor 129 of each of the basal wall brushing units 114, the water supply pump 100 and the water return pump 104 when the power switch 140 is slid into an on position.

In use, the supply water reservoir 92 is filled with an appropriate volume of water 67 and, if desired, a toothpaste is positioned in the mouthpiece 12. The mouthpiece 12 is positioned in the user's mouth 23 to surround the user's upper row of teeth 18 and the power switch 140 is slid into the on position. In this way the plurality of brushing units 108 brushes the user's teeth 18 as well as stimulating the user's gums 142 and the water recirculation unit 76 bathes the user's teeth 18 in water 67 while the user's teeth 18 are being scrubbed. Thus, the user 21 can perform dental hygiene in a manner that conforms with the methods recommended by dental professionals in an automatic and timely fashion. The power switch 140 is slid into the off position after a sufficient duration of time, ranging between approximately 5.0 seconds and 10.0 seconds and the mouthpiece 12 is repositioned in the user's mouth 23 to surround the user's lower row of teeth 22. The power switch 140 is slid into the on position to repeat the process of scrubbing the user's lower row of teeth 22 and the power switch 140 is slid into the off position after the sufficient duration of time.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An automated oral hygiene device for simultaneously cleaning all of a user's teeth while stimulating the user's gums, said device comprising:
a mouthpiece being curved between a first end and a second end of said mouthpiece such that said mouthpiece has a U-shape wherein said mouthpiece is configured to surround either an upper row of a user's teeth or a lower row of the user's teeth when said mouthpiece is positioned in the user's mouth;
a water recirculation unit being integrated into said mouthpiece to recirculate water into and out of said mouthpiece when said mouthpiece is positioned in the user's mouth wherein said water recirculation unit is configured to rinse the user's mouth when said mouthpiece is positioned in the user's mouth; and
a plurality of brushing units, each of said plurality of brushing units being movably integrated into said mouthpiece wherein each of said plurality of brushing units is configured to abut respective ones of the upper row of the user's teeth or respective ones of the lower row of the user's teeth depending upon the positioning of said mouthpiece in the user's mouth, each of said plurality of brushing units moving back and forth when said plurality of brushing units is turned on wherein each of said plurality of brushing units is configured to brush the respective ones of the upper row of the user's teeth or the respective ones of the lower row of the user's teeth thereby enhancing the dental health of the user.

2. The device according to claim 1, wherein:
said mouthpiece has a basal wall and a perimeter wall extending upwardly from said basal wall;
each of said basal wall and said perimeter wall is substantially hollow to define an interior space in said basal wall being in fluid communication with an interior space of said perimeter wall;
said perimeter wall has an outwardly facing wall which has a central portion curving outwardly between a first lateral side and a second lateral side such that said outwardly facing wall defines a U-shape;
said first lateral side terminates at said first end of said mouthpiece;
said second lateral side terminates at said second end of said mouthpiece;
said perimeter wall has an inwardly facing wall which has a middle portion curving outwardly between a first sidelong side and a second sidelong side;
said first sidelong side is spaced from and is oriented parallel to said first lateral side of said outwardly facing wall;
said second sidelong side is spaced from and is oriented parallel to said second lateral side of said outwardly facing wall;
said middle portion is spaced from and is co-arcuate with said central portion of said outwardly facing wall;
said first sidelong side terminates at said first end of said mouthpiece;
said second sidelong side terminates at said second end of said mouthpiece;
said outwardly facing wall has a plurality of first slots each extending through an inwardly facing surface of said outwardly facing wall;
each of said plurality of first slots being vertically oriented on said outwardly facing wall, said plurality of first slots being evenly spaced apart from each other and being distributed between said first end of said mouthpiece and said second end of said mouthpiece;
said inwardly facing wall has a plurality of second slots each extending through an inwardly facing surface of said inwardly facing wall;
each of said plurality of second slots is vertically oriented on said inwardly facing wall;
said plurality of second slots is evenly spaced apart from each other and is distributed between said first end of said mouthpiece and said second end of said mouthpiece;
said basal wall has a plurality of third slots each extending through an upper surface of said basal wall;
said plurality of third slots is oriented to extend substantially between said outwardly facing wall and said inwardly facing wall; and
said plurality of third slots is evenly spaced apart from each other and is distributed between said first end of said mouthpiece and said second end of said mouthpiece.

3. The device according to claim 2, wherein:
said basal wall has a pair of water intake holes each extending through said upper surface of said basal wall wherein each of said water intake holes is configured to pass water through said basal wall; and
each of said pair of water intake holes is positioned between a respective one of said first end and said second end of said mouthpiece and a respective one of a pair of endmost ones of said plurality of third slots in said basal wall.

4. The device according to claim 2, wherein:
said outwardly facing wall has a water outlet hole extending through said inwardly facing surface of said outwardly facing wall wherein said water outlet hole is configured to pass water through said outwardly facing wall; and
said water outlet hole is aligned with an apex of said central portion of said outwardly facing wall.

5. The device according to claim 2, wherein:
said device includes a stem being coupled to and extending away from an outwardly facing surface of said central portion of said outwardly facing wall of said perimeter wall of said mouthpiece;
said stem is aligned with said apex of said outwardly facing wall;
said stem has a distal end with respect to said outwardly facing surface of said central portion; and
said distal end is open.

6. The device according to claim 4, wherein:
said device includes a stem being coupled to and extending away from an outwardly facing surface of said central portion of said outwardly facing wall of said perimeter wall of said mouthpiece;
said water recirculation unit includes a water supply conduit being integrated into said stem;
said water supply conduit is in fluid communication with said water outlet hole in said outwardly facing wall;
said water recirculation unit includes a water supply hose being coupled to and extending away from said distal end of said stem;
a distal end of said water supply hose is insertable into a supply water reservoir wherein said distal end of said water supply hose is configured to be submerged in water contained in said supply water reservoir;
said water supply hose is fluidly coupled to said water outlet hole in said outwardly facing wall of said perimeter wall of said mouthpiece;
said water recirculation unit includes a water supply pump being positioned within said water supply hose; and
said water supply pump has an input and an output, said water supply pump urging water from said supply water reservoir into said input and outwardly through said output to urge the water in said supply water reservoir outwardly through said water outlet hole in said outwardly facing wall of said perimeter wall of said mouthpiece wherein said water supply pump is configured to direct the water onto the user's teeth when said mouthpiece is being worn by the user.

7. The device according to claim 3, wherein:
said device includes a stem being coupled to and extending away from an outwardly facing surface of said central portion of said outwardly facing wall of said perimeter wall of said mouthpiece;
said water recirculation unit includes a water return conduit being integrated into said mouthpiece;
said water return conduit has a stem portion being integrated into said stem and a pair of branch portions each being positioned in said interior space of said basal wall of said mouthpiece;
each of said pair of branch portions is in fluid communication with a respective one of said pair of water intake holes;
said water recirculation unit includes a water return hose being coupled to and extending away from said distal end of said stem;
a distal end of said water return hose is insertable into a return water reservoir;
said water return hose is fluidly coupled to said stem portion of said water return conduit in said stem;
said water recirculation unit includes a water return pump being positioned within said stem portion of said water return conduit; and
said water return pump has an input and an output, said water return pump urges water from said stem portion of said water return conduit into said input of said water return pump and outwardly through said output of said water return pump for urging the water in said mouthpiece into said return water reservoir through said water return hose.

8. The device according to claim 2, wherein:
said plurality of brushing units includes a set of outwardly facing wall brushing units;
each of said set of outwardly facing wall brushing units includes a first motor being positioned within said interior space of said outwardly facing wall of said perimeter wall of said mouthpiece;
each of said set of outwardly facing wall brushing units includes a first panel being slidably positioned in a respective one of said first slots in said outwardly facing wall of said perimeter wall of said mouthpiece;
a first output shaft is coupled between said first motor and a rear surface of said first panel;
said first panel is urged upwardly and downwardly in said respective first slot when said first motor is turned on;
each of said set of outwardly facing wall brushing units includes a plurality of first bristles;
each of said plurality of first bristles is coupled to and extends away from a front surface of said first panel wherein each of said plurality of first bristles is configured to frictionally engage a first lateral side of a respective one of the user's teeth when the user wears said mouthpiece thereby facilitating said plurality of first bristles to scrub the respective user's tooth when said first motor is turned on; and
said plurality of first bristles being evenly spaced apart from each other and being distributed along a full height of said first panel.

9. The device according to claim 2, wherein:
said plurality of brushing units includes a set of inwardly facing wall brushing units;
each of said set of inwardly facing wall brushing units includes a second motor being positioned within said interior space of said inwardly facing wall of said perimeter wall of said mouthpiece;
each of said set of inwardly facing wall brushing units includes a second panel being slidably positioned in a respective one of said second slots in said inwardly facing wall of said perimeter wall of said mouthpiece;
each of said set of outwardly facing wall brushing units includes a second output shaft being coupled between said second motor and a rear surface of said second panel;
said second panel is urged upwardly and downwardly in said respective second slot when said second motor is turned on; and
each of said set of outwardly facing wall brushing units includes a plurality of second bristles;
each of said plurality of second bristles is coupled to and extends away from a front surface of said second panel wherein each of said plurality of second bristles is configured to frictionally engage a second lateral side of a respective one of the user's teeth when the user wears said mouthpiece thereby facilitating said plurality of second bristles to scrub the respective user's tooth when said second motor is turned on; and
said plurality of second bristles being evenly spaced apart from each other and being distributed along a full height of said second panel.

10. The device according to claim 2, wherein:
said plurality of brushing units includes a set of basal wall brushing units;
each of said set of basal wall brushing units comprises a third motor being positioned within said interior space of said basal wall of said mouthpiece;
each of said set of basal wall brushing units comprises a third panel being slidably positioned in a respective one of said third slots in said basal wall of said mouthpiece;
each of said set of basal wall brushing units comprises a third output shaft being coupled between said third motor and a rear surface of said third panel;
said third panel is urged back and forth laterally in said respective third slot when said third motor is turned on;
each of said set of basal wall brushing units comprises a plurality of third bristles;
each of said plurality of third bristles is coupled to and extends away from a front surface of said third panel wherein each of said plurality of third bristles is configured to frictionally engage a crown surface of a respective one of the user's teeth when the user wears said mouthpiece thereby facilitating said plurality of third bristles to scrub the respective user's tooth when said third motor is turned on; and
said plurality of third bristles being evenly spaced apart from each other and being distributed along a full height of said third panel.

11. The device according to claim 1, wherein:
said plurality of brushing units including a set of outwardly facing wall brushing units and a set of inwardly facing wall brushing units and a set of basal wall brushing units;
each of said outwardly facing wall brushing units includes a first motor;
each of said inwardly facing wall brushing units includes a second motor;
each of said set of basal wall brushing units includes a third motor;
said water recirculation unit includes a water supply pump and a water return pump;
said device includes a power supply being integrated into said mouthpiece;
said power supply is electrically coupled to each of said water supply pump and said water return pump and said first motor of each of said outwardly facing wall brushing units and said second motor of each of said inwardly facing wall brushing units and said third motor of each of said basal wall brushing units.

12. The device according to claim 11, wherein:
said power supply includes a battery pack being remotely located with respect to said mouthpiece;
said power supply includes a power cord extending away from said distal end of said stem on said mouthpiece;
said power cord is electrically coupled to said battery pack;
said power cord is electrically coupled to said first motor of each of said set of outwardly facing wall brushing units and said second motor of each of said inwardly facing wall brushing units and said third motor of each of said basal wall brushing units and said water supply pump and said water return pump;
said power supply includes a power switch being slidably integrated into a lower surface of said stem wherein said power switch is configured to be manipulated by the user;
said power cord is routed through said power switch;
said power switch interrupts power to each of said first motor of each of said set of outwardly facing wall brushing units and said second motor of each of said inwardly facing wall brushing units and said third motor of each of said basal wall brushing units and said water supply pump and said water return pump when said power switch is slid into an off position; and
said power switch facilitates power to be delivered to each of said first motor of each of said set of outwardly facing wall brushing units and said second motor of each of said inwardly facing wall brushing units and said third motor of each of said basal wall brushing units and said water supply pump and said water return pump when said power switch is slid into an on position.

13. An automated oral hygiene device for simultaneously cleaning all of a user's teeth while stimulating the user's gums, said device comprising:
a mouthpiece being curved between a first end and a second end of said mouthpiece such that said mouthpiece has a U-shape wherein said mouthpiece is configured to surround either an upper row of a user's teeth or a lower row of the user's teeth when said mouthpiece is positioned in the user's mouth, said mouthpiece having a basal wall and a perimeter wall extending upwardly from said basal wall, each of said basal wall and said perimeter wall being substantially hollow to define an interior space in said basal wall being in fluid communication with an interior space of said perimeter wall, said perimeter wall having an outwardly facing wall which has a central portion curving outwardly between a first lateral side and a second lateral side such that said outwardly facing wall defines a U-shape, said first lateral side terminating at said first end of said mouthpiece, said second lateral side terminating at said second end of said mouthpiece, said perimeter wall having an inwardly facing wall which has a middle portion curving outwardly between a first sidelong side and a second sidelong side, said first sidelong side being spaced from and being oriented parallel to said first lateral side of said outwardly facing wall, said second sidelong side being spaced from and being oriented parallel to said second lateral side of said outwardly facing wall, said middle portion being spaced from and being co-arcuate with said central portion of said outwardly facing wall, said first sidelong side terminating at said first end of said mouthpiece, said second sidelong side terminating at said second end of said mouthpiece, said outwardly facing wall having a plurality of first slots each extending through an inwardly facing surface of said outwardly facing wall, each of said plurality of first slots being vertically oriented on said outwardly facing wall, said plurality of first slots being evenly spaced apart from each other and being distributed between said first end of said mouthpiece and said second end of said mouthpiece, said inwardly facing wall having a plurality of second slots each extending through an inwardly facing surface of said inwardly facing wall, each of said plurality of second slots being vertically oriented on said inwardly facing wall, said plurality of second slots being evenly spaced apart from each other and being distributed between said first end of said mouthpiece and said second end of said mouthpiece, said basal wall having a plurality of third slots each extending through an upper surface of said basal wall, said plurality of third slots being oriented to extend substantially between said outwardly facing wall and said inwardly facing wall, said plurality of third slots being evenly spaced apart from each other and being distributed between said first end of said mouthpiece and said second end of said mouthpiece, said basal wall having a pair of water intake holes each extending through said upper surface of said basal wall wherein each of said water intake holes is configured to pass water through said basal wall, each of said pair of water intake holes being positioned between a respective one of said first end and said second end of said mouthpiece and a respective one of a pair of endmost ones of said plurality of third slots in said basal wall, said outwardly facing wall having a water outlet hole extending through said inwardly facing surface of said outwardly facing wall wherein said water outlet hole is configured to pass water through said outwardly facing wall, said water outlet hole being aligned with an apex of said central portion of said outwardly facing wall;
a stem being coupled to and extending away from an outwardly facing surface of said central portion of said outwardly facing wall of said perimeter wall of said mouthpiece, said stem being aligned with said apex of said outwardly facing wall, said stem having a distal end with respect to said outwardly facing surface of said central portion, said distal end being open;
a water recirculation unit being integrated into said mouthpiece to recirculate water into and out of said mouthpiece when said mouthpiece is positioned in the user's mouth wherein said water recirculation unit is configured to rinse the user's mouth when said mouthpiece is positioned in the user's mouth, said water recirculation unit comprising:
a water supply conduit being integrated into said stem, said water supply conduit being in fluid communication with said water outlet hole;
a water return conduit being integrated into said mouthpiece, said water return conduit having a stem portion being integrated into said stem and a pair of branch portions each being positioned in said interior space of said basal wall of said mouthpiece, each of said pair of branch portions being in fluid communication with a respective one of said pair of water intake holes;
a water supply hose being coupled to and extending away from said distal end of said stem, a distal end of said water supply hose being insertable into a supply water reservoir wherein said distal end of said water supply hose is configured to be submerged in water contained in said supply water reservoir, said water supply hose being fluidly coupled to said water outlet hole in said outwardly facing wall of said perimeter wall of said mouthpiece;
a water return hose being coupled to and extending away from said distal end of said stem, a distal end of said water return hose being insertable into a return water reservoir, said water return hose being fluidly coupled to said stem portion of said water return conduit in said stem;
a water supply pump being positioned within said water supply hose, said water supply pump having an input and an output, said water supply pump urging water from supply water reservoir into said input and outwardly through output to urge the water in said supply water reservoir outwardly through said water outlet hole in said outwardly facing wall of said perimeter wall of said mouthpiece wherein said water supply pump is configured to directing the water onto the user's teeth when said mouthpiece is being worn by the user; and
a water return pump being positioned within said stem portion of said water return conduit, said water return pump having an input and an output, said water return pump urging water from said stem portion of said water return conduit into said input of said water return pump and outwardly through said output of said water return pump for urging the water in said mouthpiece into said return water reservoir through said water return hose; and
a plurality of brushing units, each of said plurality of brushing units being movably integrated into said mouthpiece wherein each of said plurality of brushing units is configured to abut respective ones of the upper row of the user's teeth or respective ones of the lower row of the user's teeth depending upon the positioning of said mouthpiece in the user's mouth, each of said plurality of brushing units moving back and forth when said plurality of brushing units is turned on wherein each of said plurality of brushing units is configured to brush the respective ones of the upper row of the user's teeth or the respective ones of the lower row of the user's teeth thereby enhancing the dental health of the user, said plurality of brushing units including a set of outwardly facing wall brushing units and a set of inwardly facing wall brushing units and a set of basal wall brushing units;
wherein each of said set of outwardly facing wall brushing units comprises:
a first motor being positioned within said interior space of said outwardly facing wall of said perimeter wall of said mouthpiece;
a first panel being slidably positioned in a respective one of said first slots in said outwardly facing wall of said perimeter wall of said mouthpiece;
a first output shaft being coupled between said first motor and a rear surface of said first panel, said first panel being urged upwardly and downwardly in said respective first slot when said first motor is turned on; and
a plurality of first bristles, each of said plurality of first bristles being coupled to and extending away from a front surface of said first panel wherein each of said plurality of first bristles is configured to frictionally engage a first lateral side of a respective one of the user's teeth when the user wears said mouthpiece thereby facilitating said plurality of first bristles to scrub the respective user's tooth when said first motor is turned on, said plurality of first bristles being evenly spaced apart from each other and being distributed along a full height of said first panel;
wherein each of said set of inwardly facing wall brushing units comprises:
a second motor being positioned within said interior space of said inwardly facing wall of said perimeter wall of said mouthpiece;
a second panel being slidably positioned in a respective one of said second slots in said inwardly facing wall of said perimeter wall of said mouthpiece;
a second output shaft being coupled between said second motor and a rear surface of said second panel, said second panel being urged upwardly and downwardly in said respective second slot when said second motor is turned on; and
a plurality of second bristles, each of said plurality of second bristles being coupled to and extending away from a front surface of said second panel wherein each of said plurality of second bristles is configured to frictionally engage a second lateral side of a respective one of the user's teeth when the user wears said mouthpiece thereby facilitating said plurality of second bristles to scrub the respective user's tooth when said second motor is turned on, said plurality of second bristles being evenly spaced apart from each other and being distributed along a full height of said second panel;
wherein each of said set of basal wall brushing units comprises:
a third motor being positioned within said interior space of said basal wall of said mouthpiece;
a third panel being slidably positioned in a respective one of said third slots in said basal wall of said mouthpiece;
a third output shaft being coupled between said third motor and a rear surface of said third panel, said third panel being urged back and forth laterally in said respective third slot when said third motor is turned on; and
a plurality of third bristles, each of said plurality of third bristles being coupled to and extending away from a front surface of said third panel wherein each of said plurality of third bristles is configured to frictionally engage a crown surface of a respective one of the user's teeth when the user wears said mouthpiece thereby facilitating said plurality of third bristles to scrub the respective user's tooth when said third motor is turned on, said plurality of third bristles being evenly spaced apart from each other and being distributed along a full height of said third panel; and
a power supply being integrated into said mouthpiece, said power supply being electrically coupled to each of said water supply pump and said water return pump and said first motor of each of said outwardly facing wall brushing units and said second motor of each of said inwardly facing wall brushing units and said third motor of each of said basal wall brushing units, said power supply comprising:
a battery pack being remotely located with respect to said mouthpiece;
a power cord extending away from said distal end of said stem on said mouthpiece, said power cord being electrically coupled to said battery pack, said power cord being electrically coupled to said first motor of each of said set of outwardly facing wall brushing units and said second motor of each of said inwardly facing wall brushing units and said third motor of each of said basal wall brushing units and said water supply pump and said water return pump; and
a power switch being slidably integrated into a lower surface of said stem wherein said power switch is configured to be manipulated by the user, said power cord being routed through said power switch, said power switch interrupting power to each of said first motor of each of said set of outwardly facing wall brushing units and said second motor of each of said inwardly facing wall brushing units and said third motor of each of said basal wall brushing units and said water supply pump and said water return pump when said power switch is slid into an off position, said power switch facilitating power to be delivered to each of said first motor of each of said set of outwardly facing wall brushing units and said second motor of each of said inwardly facing wall brushing units and said third motor of each of said basal wall brushing units and said water supply pump and said water return pump when said power switch is slid into an on position.
